(19) United States
(12) Patent Application Publication
(10) Pub. No.: US 2026/0155429 A1
(43) Pub. Date: Jun. 4, 2026

(54) ANODE-FREE TYPE LITHIUM SECONDARY BATTERY INCLUDING LIQUID METAL PARTICLES AND POLYMER ELECTROLYTE AND METHOD OF MANUFACTURING SAME

(71) Applicant: The Industry & Academic Cooperation in Chungnam National University (IAC), Daejeon (KR)

(72) Inventors: Minh Hai Nguyen, Daejeon (KR); Do Hun Kim, Daejeon (KR); SangBaek Park, Daejeon (KR)

(73) Assignee: The Industry & Academic Cooperation in Chungnam National University (IAC), Daejeon (KR)

(21) Appl. No.: 19/261,234

(22) Filed: Jul. 7, 2025

(30) Foreign Application Priority Data
Dec. 4, 2024 (KR) 10-2024-0178236

(51) Int. Cl. H01M 10/0525; H01M 4/02; H01M 4/04; H01M 10/0565; H01M 10/0569; H01M 10/0585

(52) U.S. Cl. CPC H01M 10/0525; H01M 4/0404; H01M 4/0407; H01M 10/0565; H01M 10/0569; H01M 10/0585; H01M 2004/027; H01M 2004/028; H01M 2300/0028; H01M 2300/0082

(57) ABSTRACT

Disclosed are an anode-free type lithium secondary battery including liquid metal particles and a polymer electrolyte and a method of manufacturing the same.

### CROSS-REFERENCE TO RELATED APPLICATION

This application claims, under 35 U.S.C. § 119 (a), the benefit of priority from Korean Patent Application No. 10-2024-0178236, filed on Dec. 4, 2024, the entire contents of which are incorporated herein by reference.

### BACKGROUND

### (a) Technical Field

The present disclosure relates to an anode-free type lithium secondary battery including liquid metal particles and a polymer electrolyte and a method of manufacturing the same.

### (b) Background Art

Lithium secondary batteries have to satisfy certain standards, including long lifespan, fast charging, high safety levels, stable cycling performance, etc. In most currently-commercialized lithium secondary batteries, graphite is used as a cathode material, but has low volumetric capacity and specific capacity. In contrast, lithium (Li) metal has emerged as a promising alternative for increasing the energy density of lithium secondary batteries due to low electrochemical potential, high theoretical capacity, and high volumetric capacity. However, lithium metal still faces several important challenges for commercialization, including safety concerns, short cycle life, low Coulombic efficiency (CE), volume expansion due to side reaction and/or lithium dendrite growth, etc.

To solve this problem, an anode-free type battery using only an anode current collector instead of a conventional anode has been developed. In an anode-free type battery, the cathode acts as a source of lithium metal, and lithium ions are extracted during charging and plated onto the anode current collector. By removing the excess lithium metal and other anode active material layers, the overall weight and volume of the lithium secondary battery may be significantly reduced, thereby greatly increasing the energy density. Also, manufacturing costs may be reduced by virtue of the assembly process without lithium foil. This configuration has been studied in liquid electrolyte-based lithium secondary batteries, but it faces limitations such as rapid growth of dendrites due to uneven deposition of lithium on the anode current collector, rapid drop in Coulombic efficiency due to high reactivity of lithium with the liquid electrolyte, and safety hazards.

With the goal of solving this problem, attempts have been made to replace liquid electrolytes with solid electrolytes. Solid electrolytes have no problems such as leakage and flammability and may serve to stabilize the interfacial contact between the lithium metal deposited during charging and the electrolyte. However, the electrolyte layer including the solid electrolyte is thick, which has a negative effect on the energy density of the battery. Thinning the solid electrolyte may be a potential solution, but it still faces significant hurdles in view of practical mass production.

### SUMMARY OF THE DISCLOSURE

An aspect of the present disclosure is to provide an anode-free type lithium secondary battery in which lithium is uniformly deposited during charging and a method of manufacturing the same.

Another aspect of the present disclosure is to provide an anode-free type lithium secondary battery having excellent Coulombic efficiency and a method of manufacturing the same.

Still another aspect of the present disclosure is to provide an anode-free type lithium secondary battery having good cycling performance and a method of manufacturing the same.

Yet another aspect of the present disclosure is to provide an anode-free type lithium secondary battery having excellent stability and high energy density and a method of manufacturing the same.

The aspects of the present disclosure are not limited to the foregoing. The aspects of the present disclosure will be able to be clearly understood through the following description and to be realized by the means described in the claims and combinations thereof.

An embodiment of the present disclosure provides a lithium secondary battery, including an anode current collector, a thin film layer disposed on the anode current collector and including liquid metal particles, an electrolyte layer disposed on the thin film layer and including a polymer electrolyte, a cathode active material layer disposed on the electrolyte layer, and a cathode current collector disposed on the cathode active material layer.

The liquid metal particles may include at least one selected from the group consisting of Ga, Ga—In, Ga—In—Sn, and combinations thereof.

The Ga—In may include 75 wt % of Ga and 25 wt % of In.

The Ga—In—Sn may include 67 wt % of Ga, 20.5 wt % of In, and 12.5 wt % of Sn.

The size of the liquid metal particles may be 10 nm to 60 nm.

The loading amount of the liquid metal particles may be 0.5 mg/cm² to 1.0 mg/cm².

The thin film layer may further include a carbon material and a binder.

The thin film layer may include 2 wt % to 10 wt % of the carbon material, 40 wt % to 70 wt % of the liquid metal particles, and 20 wt % to 50 wt % of the binder.

The thickness of the thin film layer may be 5 μm to 20 μm.

The polymer electrolyte may include a compound represented by Chemical Formula 1 below.

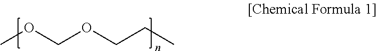

In Chemical Formula 1, n may be a number ranging from 1,000 to 10,000.

At least a portion of the electrolyte layer may penetrate the thin film layer.

The lithium secondary battery may further include a lithium metal layer between the thin film layer and the anode current collector during charging.

Peaks may be observed at 2θ=25°±0.5° and 40°±0.5° based on results of X-ray diffraction analysis for the thin film layer during charging of the lithium secondary battery.

Another embodiment of the present disclosure provides a method of manufacturing a lithium secondary battery, including forming a thin film layer by applying a mixture including liquid metal particles, a carbon material, and a binder onto an anode current collector, forming an electrolyte layer including a polymer electrolyte by applying an electrolyte composition onto the thin film layer and polymerizing the electrolyte composition, and introducing a cathode active material layer and a cathode current collector onto the electrolyte layer.

The electrolyte composition may include 3 M or more of a lithium salt and a solvent including a heterocyclic compound.

The lithium salt may include lithium bis(trifluoromethanesulfonyl)imide (LiFSI), and the solvent may include 1,3-dioxolane, and optionally, the solvent may further include 1,2-dimethoxyethane.

Forming the electrolyte layer may include applying an electrolyte composition onto the thin film layer and allowing the electrolyte composition to stand at 20° C. to 25° C. for 24 hours or more to polymerize the electrolyte composition.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an anode-free type lithium secondary battery according to the present disclosure;

FIG. 2 shows the lithium secondary battery of FIG. 1 in a charged state;

FIG. 3 shows the cross-section of an intermediate including an anode current collector and a thin film layer (LM-C) according to Preparation Example 5 observed using a scanning electron microscope (SEM);

FIG. 4 shows results of evaluation of the cycling performance of Example 1;

FIG. 5 shows results of evaluation of the cycling performance of Example 2;

FIG. 6 shows results of evaluation of the cycling performance of Example 3;

FIG. 7 shows results of evaluation of the cycling performance of Comparative Example 1;

FIG. 8 shows results of measurement of the Coulombic efficiency of Examples 1 to 3 and Comparative Example 1;

FIG. 9 shows results of evaluation of the cycling performance of Example 4;

FIG. 10 shows results of evaluation of the cycling performance of Example 5;

FIG. 11 shows results of evaluation of the cycling performance of Example 6;

FIG. 12 shows results of evaluation of the cycling performance of Comparative Example 2;

FIG. 13 shows results of measurement of the Coulombic efficiency of Examples 4 to 6 and Comparative Example 2;

FIG. 14 shows results of measurement of the lithium deposition profiles of Examples 4 to 6 and Comparative Example 2;

FIG. 15 shows results of X-ray diffraction analysis for the thin film layer of Example 4;

FIG. 16 shows results of X-ray diffraction analysis for the thin film layer of Example 5;

FIG. 17 shows results of X-ray diffraction analysis for the thin film layer of Example 6;

FIG. 18 shows results of X-ray diffraction analysis for the thin film layer of Comparative Example 2;

FIG. 19 shows results of Raman analysis for the thin film layer of Example 4;

FIG. 20 shows results of Raman analysis for the thin film layer of Example 5;

FIG. 21 shows results of Raman analysis for the thin film layer of Example 6;

FIG. 22 shows results of Raman analysis for the thin film layer of Comparative Example 2;

FIG. 23 shows results of visual observation of the electrolytes according to Preparation Example 6 and Comparative Preparation Example 2;

FIG. 24 shows ¹H NMR results for Preparation Example 6;

FIG. 25 shows ¹³C NMR results for Preparation Example 6;

FIG. 26 shows results of measurement of the Coulombic efficiency of Example 7 and Comparative Examples 3 to 5;

FIG. 27 shows results of measurement of the nucleation energy of Example 7;

FIG. 28 shows results of measurement of the nucleation energy of Comparative Example 3;

FIG. 29 shows results of measurement of the nucleation energy of Comparative Example 4;

FIG. 30 shows results of measurement of the nucleation energy of Comparative Example 5;

FIG. 31 shows results of scanning electron microscopy of the liquid metal particles of Example 8;

FIG. 32 shows results of scanning electron microscopy of the liquid metal particles of Comparative Example 6;

FIG. 33 shows results of scanning electron microscopy of the liquid metal particles of Comparative Example 7;

FIG. 34 shows results of evaluation of the cycling performance of Example 8;

FIG. 35 shows results of evaluation of the cycling performance of Comparative Example 6;

FIG. 36 shows results of evaluation of the cycling performance of Comparative Example 7;

FIG. 37 shows results of measurement of the Coulombic efficiency of Example 8 and Comparative Examples 6 and 7;

FIG. 38 shows charge/discharge curves of Example 8;

FIG. 39 shows charge/discharge curves of Comparative Example 6;

FIG. 40 shows charge/discharge curves of Comparative Example 7;

FIG. 41 shows EDS-mapping results of Example 8;

FIG. 42 shows EDS-mapping results of Comparative Example 6;

FIG. 43 shows EDS-mapping results of Comparative Example 7; and

FIG. 44 shows Nyquist plots of Example 8 and Comparative Examples 6 and 7.

### DETAILED DESCRIPTION

The above and other aspects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

The present disclosure relates to an anode-free type lithium secondary battery. The anode-free type lithium secondary battery may be a battery responsible for storage and movement of lithium ions (Li⁺) without an anode in the configuration of a traditional lithium secondary battery. The anode-free type lithium secondary battery is configured to include only a cathode and an electrolyte, and lithium ions move through the electrolyte from the cathode and are directly precipitated and stored on the anode current collector.

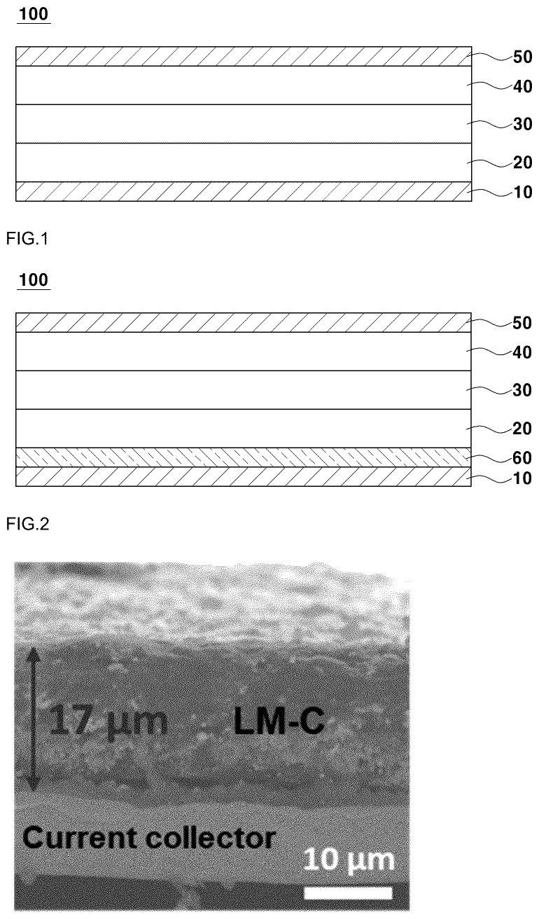

FIG. 1 shows an anode-free type lithium secondary battery according to the present disclosure. FIG. 2 shows the lithium secondary battery of FIG. 1 in a charged state.

The lithium secondary battery 100 may include an anode current collector 10, a thin film layer 20, an electrolyte layer 30, a cathode active material layer 40, and a cathode current collector 50. The lithium secondary battery 100 may further include a lithium metal layer 60 between the anode current collector 10 and the thin film layer 20 during charging. Since the lithium secondary battery does not include a material that functions as an anode active material, lithium ions (Li⁺) released from the cathode active material layer 40 may be precipitated and stored on the anode current collector 50 through the electrolyte layer 30 and the thin film layer 20 during charging, thus forming the lithium metal layer 60.

The anode current collector 10 may include a plate-shaped substrate having electrical conductivity. The anode current collector 10 may include copper (Cu), nickel (Ni), stainless steel, etc.

The anode current collector 10 may include a high-density metal thin film having a porosity of less than about 1%.

The thickness of the anode current collector 10 is not particularly limited and may be, for example, 1 μm to 20 μm, or 5 μm to 15 μm.

The thin film layer 20 may include liquid metal particles, a carbon material, a binder, etc.

The liquid metal particles may react with lithium ions to form an alloy phase. The alloy phase may act as a kind of seed. Specifically, since the alloy phase is lithiophilic, the lithium ions may pass through the thin film layer 20 more easily and evenly, and accordingly, the lithium metal layer 60 may be formed uniformly.

The liquid metal particles may include at least one selected from the group consisting of Ga, Ga—In, Ga—In—Sn, and combinations thereof. The Ga—In may refer to an alloy, an intermetallic compound, etc. of gallium (Ga) and indium (In). The Ga—In—Sn may refer to an alloy, an intermetallic compound, etc. of gallium (Ga), indium (In), and tin (Sn). The Ga—In may include, for example, 75 wt % of Ga and 25 wt % of In. The Ga—In—Sn may include 67 wt % of Ga, 20.5 wt % of In, and 12.5 wt % of Sn.

The liquid metal particles may be present in a solid state during charging and in a liquid state during discharging. Since the liquid metal particles have self-healing ability through reversible phase transition during charging and discharging, cracks formed in the thin film layer 20 due to volume expansion during charging and discharging may be effectively treated.

The liquid metal particles, having a nanoscale size to a microscale size, may be present in the form of particles that contain liquid metal but are solid at room temperature. Preferably, the size of the liquid metal particles ranges from 10 nm to 60 nm. The size may mean a diameter of the liquid metal particles. When the size of the liquid metal particles falls within the above numerical range, the liquid metal particles may be evenly distributed in the thin film layer 20. The above size may indicate the diameter of the particles when the liquid metal particles are present in a solid state. The size of the liquid metal particles may be measured using a laser diffraction scattering particle size distribution analyzer, for example, a Microtrac particle size distribution analyzer. Alternatively, 200 particles may be randomly extracted from the electron micrograph and the average particle diameter thereof may be determined.

The loading amount of the liquid metal particles may be 0.5 mg/cm² to 1.0 mg/cm². The loading amount of the liquid metal particles may be based on the thin film layer. When the loading amount thereof falls within the above numerical range, the liquid metal particles may form an alloy with lithium ions, the alloy functioning as a seed.

The carbon material may be a conductive material for electron conduction in the thin film layer 20, rather than an anode active material such as graphite, etc. Specifically, the carbon material may be a component that does not electrochemically react with lithium ions and does not directly participate in storage and release of lithium ions.

The carbon material may include carbon black, carbon nanotubes, etc.

The binder may serve to bond the liquid metal particles and/or the carbon material. The type of binder is not particularly limited, and examples thereof may include polyvinylidene fluoride (PVDF), polytetrafluoroethylene (PTFE), polyvinyl alcohol, and the like.

The thin film layer 20 may include 2 wt % to 10 wt % of the carbon material, 40 wt % to 70 wt % of the liquid metal particles, and 20 wt % to 50 wt % of the binder. When the amount of each component falls within the above numerical range, the effect of introducing the thin film layer 20 may be maximized.

The thickness of the thin film layer 20 may be 5 μm to 20 μm. If the thickness thereof is less than 5 μm, the lithium metal layer 60 may not be formed uniformly, whereas if it exceeds 20 μm, the energy density of the lithium secondary battery 100 may decrease.

The electrolyte layer 30 may include a polymer electrolyte. The polymer electrolyte has low density, excellent flexibility, and superior stability compared to a liquid electrolyte, making it possible to improve various characteristics of the lithium secondary battery 100.

The polymer electrolyte may include a compound represented by Chemical Formula 1 below.

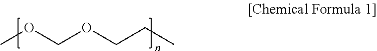

In Chemical Formula 1, n may be a number ranging from 1,000 to 10,000.

The electrolyte layer 30 may be provided in the form in which at least a portion thereof penetrates the thin film layer 20. This is because the electrolyte layer 30 is formed by in-situ polymerization, which will be described later. For example, 1% to 10%, 2% to 10%, or 3% to 10% of the thickness of the electrolyte layer 30 based on the cross-section of the electrolyte layer 30 may penetrate the thin film layer 20. Accordingly, lithium ions may move more easily to the thin film layer 20 through the electrolyte layer 30.

The electrolyte layer 30 may optionally further include a liquid electrolyte, a solid electrolyte, etc. The liquid electrolyte and solid electrolyte may include any one widely used in the technical field to which the present disclosure belongs.

The cathode active material layer 40 may include a cathode active material.

The cathode active material may include, for example, a nickel-cobalt-manganese-based active material, preferably LiNi_{0.8}Co_{0.1}Mn_{0.1}O₂.

The cathode current collector 50 may include a plate-shaped substrate having electrical conductivity. The cathode current collector 60 may include aluminum foil.

The cathode current collector 50 may include a high-density metal thin film having a porosity of less than about 1%.

The thickness of the cathode current collector 50 is not particularly limited and may be, for example, 1 μm to 20 μm, or 5 μm to 15 μm.

A method of manufacturing the anode-free type lithium secondary battery according to the present disclosure may include forming a thin film layer by applying a mixture including liquid metal particles, a carbon material, and a binder onto an anode current collector, forming an electrolyte layer including a polymer electrolyte by applying an electrolyte composition onto the thin film layer and polymerizing the electrolyte composition, and introducing a cathode active material layer and a cathode current collector onto the electrolyte layer.

The thin film layer and components thereof are as described above and a description thereof is omitted below. The method and conditions for applying the mixture are not particularly limited, and any method and condition widely used in the technical field to which the present disclosure belongs should be interpreted as falling within the scope of the present disclosure.

The electrolyte composition may include 3 M or more of a lithium salt and a solvent including a heterocyclic compound.

The lithium salt may include lithium bis(trifluoromethanesulfonyl)imide (LiFSI). The solvent may include 1,3-dioxolane. When the concentration of the lithium salt is 3 M or more, ring opening of 1,3-dioxolane may be induced through head bonding of Li⁺ and FSI⁻, and accordingly, the electrolyte composition may be polymerized to form a polymer electrolyte.

The solvent may optionally further include 1,2-dimethoxyethane.

Forming the electrolyte layer may include applying an electrolyte composition onto the thin film layer and allowing the same to stand at 20° C. to 25° C. for 24 hours or more to polymerize the electrolyte composition. When the electrolyte composition is applied onto the thin film layer, at least a portion of the electrolyte composition penetrates the thin film layer and the electrolyte composition is in-situ polymerized in that state, so that at least a portion of the electrolyte layer may be in a state of penetrating the thin film layer.

The method of introducing the cathode active material layer and the cathode current collector is not particularly limited. For example, a cathode active material layer may be formed by applying a slurry including a cathode active material onto an electrolyte layer followed by drying, or a cathode active material layer formed by applying the slurry onto a substrate followed by drying may be stacked on the electrolyte layer.

A better understanding of the present disclosure may be obtained through the following examples. These examples are merely set forth to illustrate the present disclosure, and are not to be construed as limiting the scope of the present disclosure.

### Preparation Examples 1 to 5

To manufacture liquid metal particles, Ga (99.99%, KOJUNDO), In (99%, KOJUNDO), and Sn (99.5%, Sigma-Aldrich) as raw materials were purchased. Bulk eutectic alloy samples were manufactured in the ratios shown in Table 1 below. Each sample was added to an acetone solution and treated with an ice sonicator, thus manufacturing liquid metal particles. The intensity of the ultrasound was fixed at about 500 W, and the treatment time was about 2 hours. Ice and cold water were frequently placed in the sonication bath to keep the temperature of the sample at 20° C. or less during sonication.

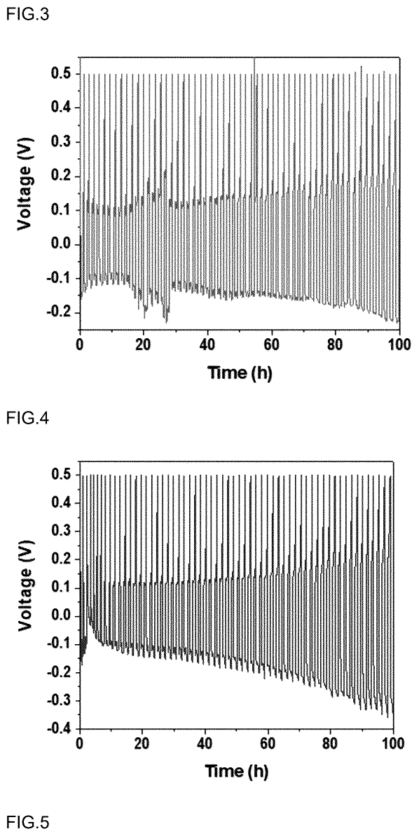

The liquid metal particles thus manufactured were mixed with PVDF as a binder and Super P as a carbon material at a low temperature to afford a mixture. The amount of each component is shown in Table 1 below. The mixture was applied onto a stainless steel foil having a thickness of about 10 μm and dried, thereby obtaining an intermediate including an anode current collector and a thin film layer. FIG. 3 shows the cross-section of the intermediate including the anode current collector and the thin film layer (LM-C) according to Preparation Example 5 observed using a scanning electron microscope (SEM).

TABLE 1

| | | | Liquid metal particles | | | | | |
|---|---|---|---|---|---|---|---|---|
| | | Carbon | | | | | Loading | |
| | | material | Ga | In | Sn | Total | amount | Binder |
| Classification | Composition | [mg] | [wt %] | [wt %] | [wt %] | [mg] | [mg/cm²] | [mg] |
| Comparative | C only | 60 | 0 | 0 | 0 | 0 | 0 | 800 |
| Preparation Example 1 | | | | | | | | |
| Preparation Example 1 | GaIn1—C | 60 | 75 | 25 | 0 | 900 | 0.5 | 800 |
| Preparation Example 2 | GaIn2—C | 60 | 75 | 25 | 0 | 1,200 | 0.66 | 800 |
| Preparation Example 3 | GaIn3—C | 60 | 75 | 25 | 0 | 1,500 | 0.83 | 800 |
| Preparation Example 4 | Ga—C | 60 | 100 | 0 | 0 | 1,500 | 0.83 | 800 |
| Preparation Example 5 | GaInSn—C | 60 | 67 | 20.5 | 12.5 | 1,500 | 0.83 | 800 |

### Comparative Preparation Example 1

As shown in Table 1, an intermediate was obtained by forming a thin film layer only using a carbon material and a binder without using liquid metal particles.

### Examples 1 to 3 and Comparative Example 1

An asymmetric cell was manufactured using the intermediate according to each of Preparation Examples 1 to 3 and Comparative Preparation Example 1. A separator was stacked on each intermediate, and lithium metal was attached to the separator. LiPF₆ in DEC/EC (1:1 v/v) was injected as the electrolyte.

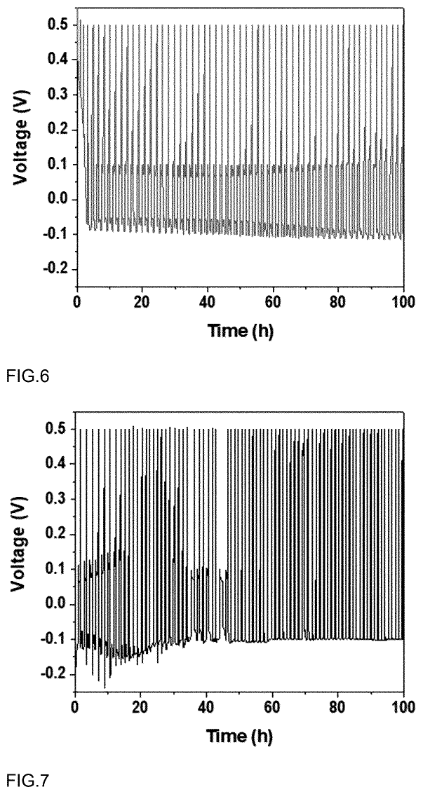

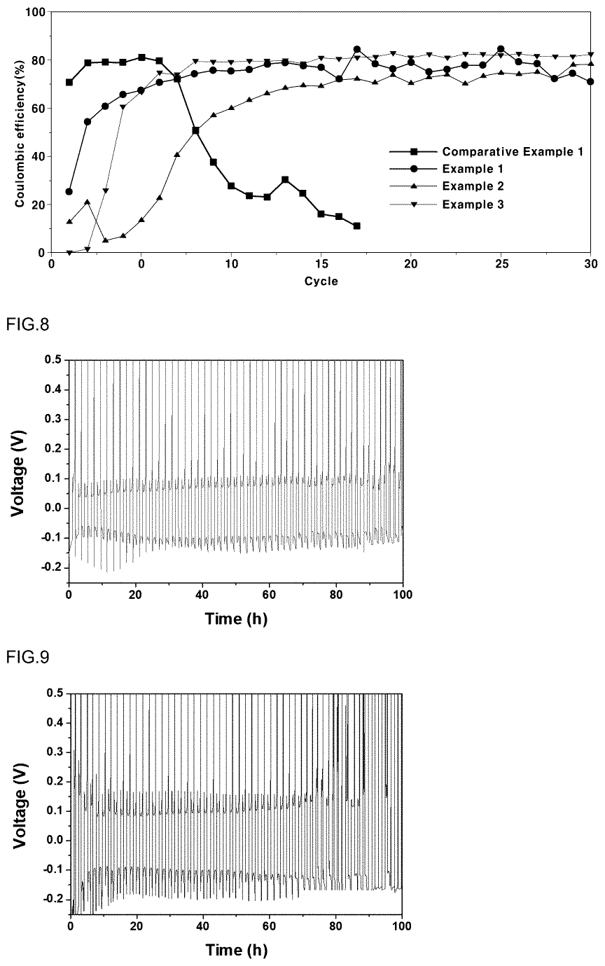

FIG. 4 shows results of evaluation of the cycling performance of Example 1. FIG. 5 shows results of evaluation of the cycling performance of Example 2. FIG. 6 shows results of evaluation of the cycling performance of Example 3. FIG. 7 shows results of evaluation of the cycling performance of Comparative Example 1. FIG. 8 shows results of measurement of the Coulombic efficiency of Examples 1 to 3 and Comparative Example 1.

Referring to FIG. 7, Comparative Example 1 without liquid metal particles had deteriorated cycling performance. In particular, referring to FIG. 8, the Coulombic efficiency of Comparative Example 1 was much lower than that of Examples 1 to 3. Comparative Example 1 failed after only 17 cycles of charging and discharging, during which the average Coulombic efficiency was only about 46%. The poor cycling behavior of Comparative Example 1 may cause volume expansion and an unstable solid electrolyte interfacial layer, which may lead to problems such as uneven lithium deposition, layer cracking, and short circuit.

On the other hand, referring to FIGS. 4 to 6 and 8, Examples 1 to 3 including liquid metal particles exhibited greatly improved cycling behavior and Coulombic efficiency. All of Examples 1 to 3 maintained operation even after 100 hours of testing. In particular, Example 3 showed the lowest and most stable voltage polarization and the highest average Coulombic efficiency.

### Examples 4 to 6 and Comparative Example 2

An asymmetric cell was manufactured in the same manner as in Example 1 using the intermediate according to each of Preparation Examples 3 to 5 and Comparative Preparation Example 1.

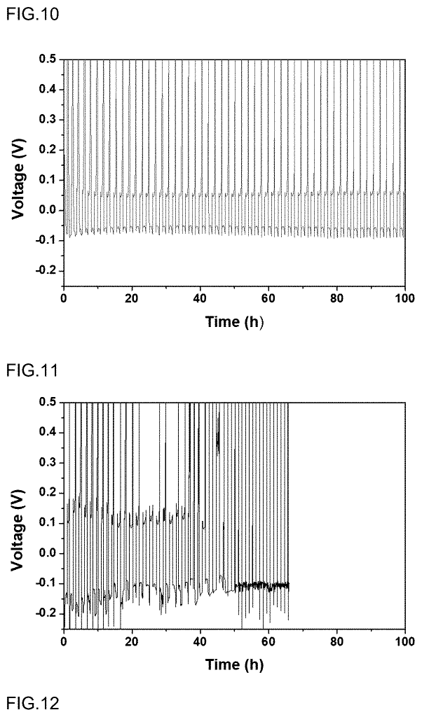

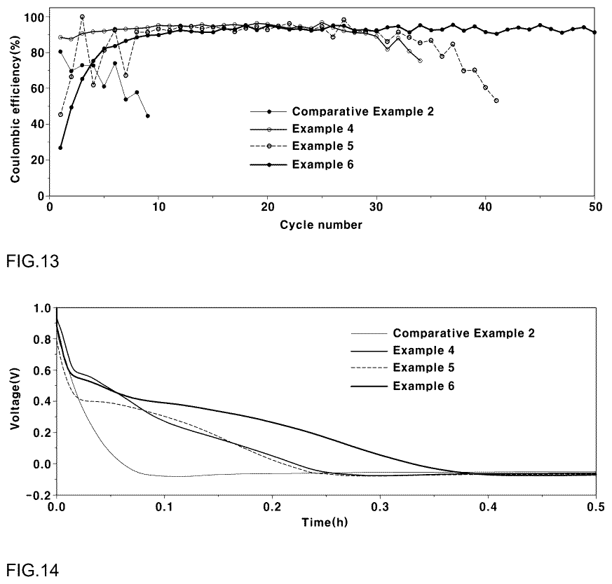

FIG. 9 shows results of evaluation of the cycling performance of Example 4. FIG. 10 shows results of evaluation of the cycling performance of Example 5. FIG. 11 shows results of evaluation of the cycling performance of Example 6. FIG. 12 shows results of evaluation of the cycling performance of Comparative Example 2. FIG. 13 shows results of measurement of the Coulombic efficiency of Examples 4 to 6 and Comparative Example 2. FIG. 14 shows results of measurement of the lithium deposition profiles of Examples 4 to 6 and Comparative Example 2.

Examples 4 to 6 exhibited obviously improved lithium deposition stability and performance compared to Comparative Example 2. These results are due to the alloying reaction between liquid metal particles and lithium and the self-healing ability of the liquid metal particles. Referring to FIGS. 9 to 11, Examples 4 to 6 showed a distinct plateau during the initial cycle, indicating initial interaction between lithium and liquid metal particles. By providing a favorable initial site for precipitation and storage of lithium by lithium nucleation, the lithium metal layer may be more uniformly and densely formed.

In particular, Example 6 including Ga—In—Sn liquid metal particles exhibited the highest and most stable Coulombic efficiency at low voltage polarization. Ga—In—Sn has a lower melting point than Ga and Ga—In, which facilitates reversible phase transition during charging and discharging, and thus cracks caused by volume expansion may be more efficiently treated.

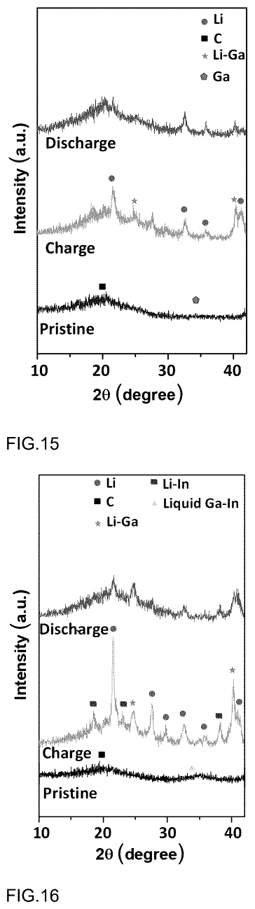

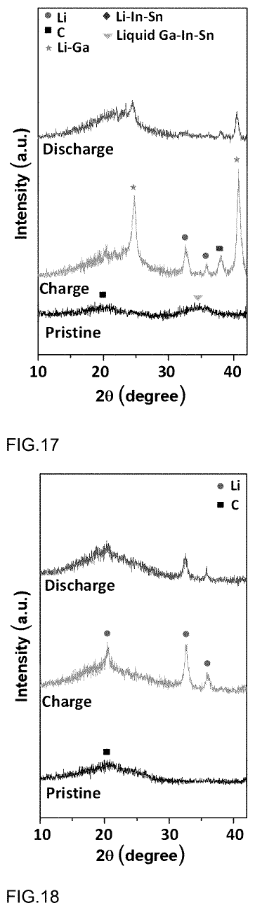

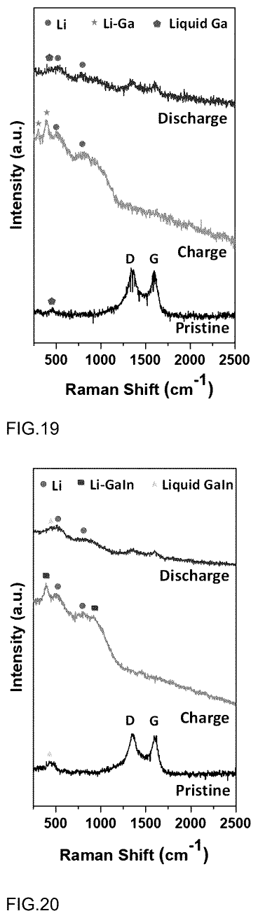

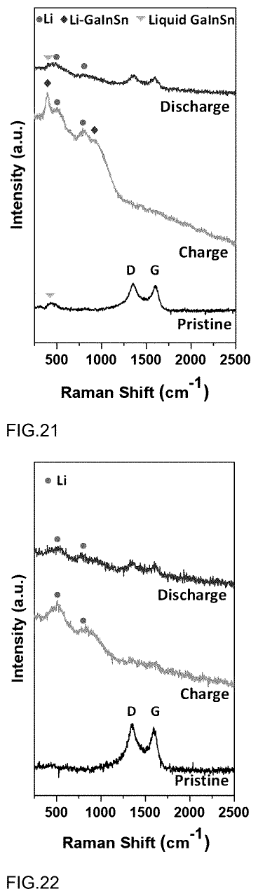

FIG. 15 shows results of X-ray diffraction analysis for the thin film layer of Example 4. FIG. 16 shows results of X-ray diffraction analysis for the thin film layer of Example 5. FIG. 17 shows results of X-ray diffraction analysis for the thin film layer of Example 6. FIG. 18 shows results of X-ray diffraction analysis for the thin film layer of Comparative Example 2. In Comparative Example 2, only peaks corresponding to lithium were found, whereas in Examples 4 to 6, peaks corresponding to Li—Ga (Li₅Ga₄) were observed at 2θ=25°±0.5° and 40°±0.5°, and in Examples 5 and 6, peaks corresponding to Li—In (Li₃In₂), Li—In—Sn, etc. were observed in addition thereto. The disappearance of the peak corresponding to the initial liquid metal particles is due to the interaction of lithium ions with the liquid metal particles during charging, leading to the formation of an alloy phase. After subsequent discharging, the peaks of the alloys decreased due to the dealloying process. Furthermore, the alloying-dealloying mechanism is further supported by the Raman results. FIG. 19 shows results of Raman analysis for the thin film layer of Example 4. FIG. 20 shows results of Raman analysis for the thin film layer of Example 5. FIG. 21 shows results of Raman analysis for the thin film layer of Example 6. FIG. 22 shows results of Raman analysis for the thin film layer of Comparative Example 2. Referring thereto, phase transition from the alloy of lithium and liquid metal particles to the peak of the liquid metal particles can be clearly observed, which is similar to that of the pristine sample after the discharging process. This indicates that the self-healing ability of liquid metal particles greatly contributes to the performance of lithium secondary batteries.

### Preparation Example 6

3 M LiFSI was dissolved in anhydrous 1,2-dimethoxyethane (DME) and 1,3-dioxolane (DOL) (1/1, v/v) as solvents using a stirrer and then aged at room temperature for 24 hours. This experiment was performed in a glove box with an argon atmosphere having low oxygen content and low H₂O concentration.

### Comparative Preparation Example 2

To investigate the effect of lithium salt content, LiFSI at various concentrations (1 M and 2 M) was prepared and analyzed. In addition, various combinations of lithium salts and solvents were prepared and compared with the polymer electrolyte according to Preparation Example 6.

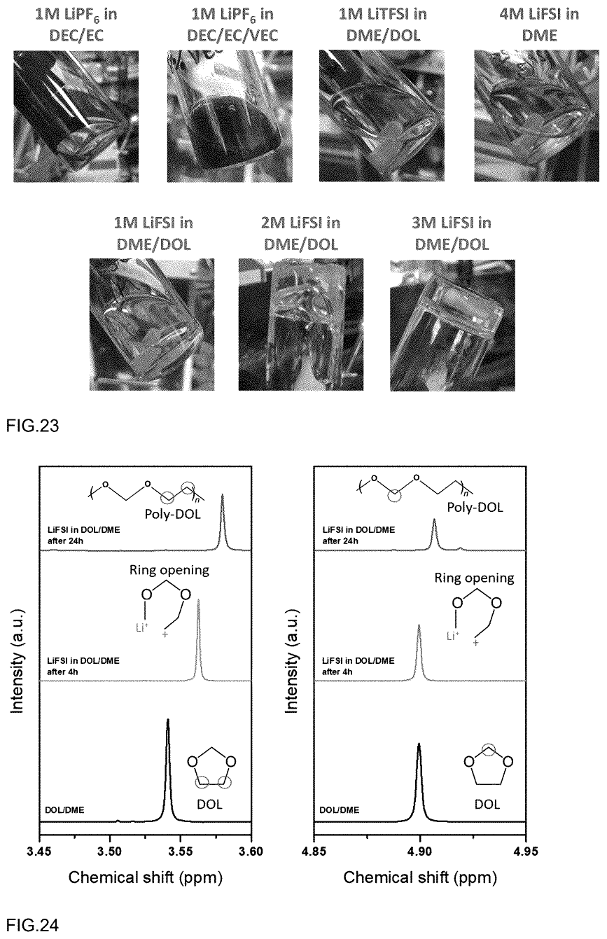

FIG. 23 shows results of visual observation of the electrolytes according to Preparation Example 6 and Comparative Preparation Example 2. Conventional electrolytes such as LiPF₆ and LiTFSI remained in a liquid state. In Preparation Example 6, 3 M LiFSI in DME/DOL was transformed into a transparent polymer electrolyte. On the other hand, 1 M LiFSI in DME/DOL remained in a liquid state, and 2 M LiFSI in DME/DOL gelled but some thereof flowed down along the wall, making it somewhat difficult to use the same as a polymer electrolyte. Meanwhile, 4 M LiFSI dissolved only in DME still remained in a liquid state. This means that LiFSI and DOL are important.

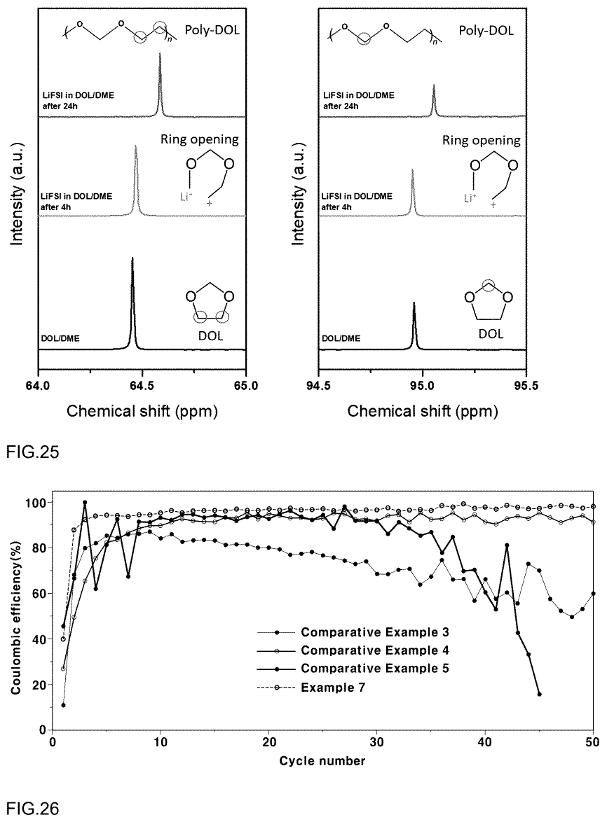

FIG. 24 shows 1H NMR results for Preparation Example 6. FIG. 25 shows ¹³C NMR results for Preparation Example 6. The DOL ring showed two peaks at 3.54 ppm and 4.89 ppm in ¹H NMR and two other peaks at 64.44 ppm and 94.95 ppm in ¹³C NMR. After gelation for 24 hours, these peaks shifted to new chemical changes corresponding to H and C of the —O—CH₂—CH₂—O— and —O—CH₂—O— groups. This indicates that high concentration of LiFSI is capable of effectively inducing ring opening of the DOL molecule through head bonding with Li⁺ and FSI⁻, resulting in in-situ polymerization of these monomers.

### Example 7

An asymmetric cell was manufactured by forming an electrolyte layer including the polymer electrolyte according to Preparation Example 6 on a composite including Ga—In—Sn according to Preparation Example 5 and attaching lithium metal to the electrolyte layer.

### Comparative Examples 3 to 5

Respective asymmetric cells were manufactured in the same manner as in Example 7, with the exception that the electrolytes were replaced with LiPF₆, LiPF₆-VEC, and LiTFSI. For reference, since these electrolytes are in a liquid state, a separator was disposed on the composite and then each electrolyte was injected into the separator.

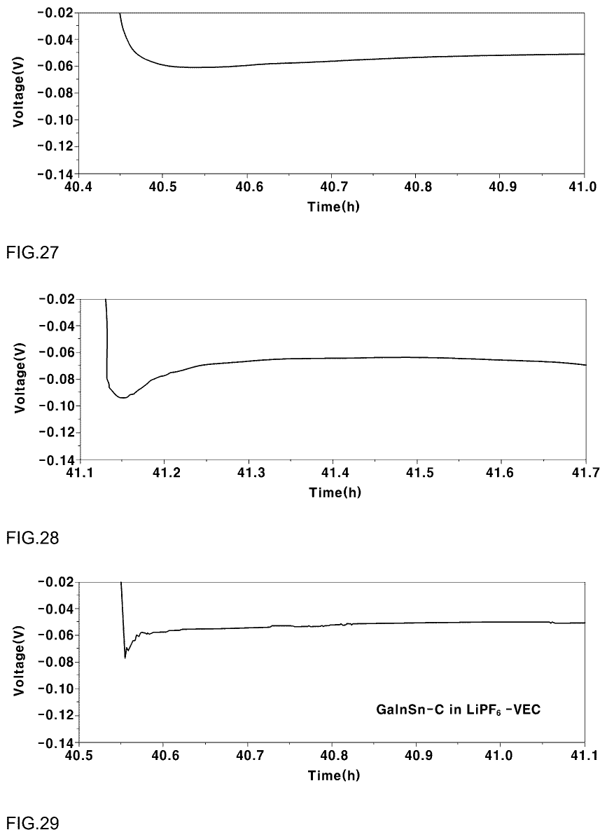

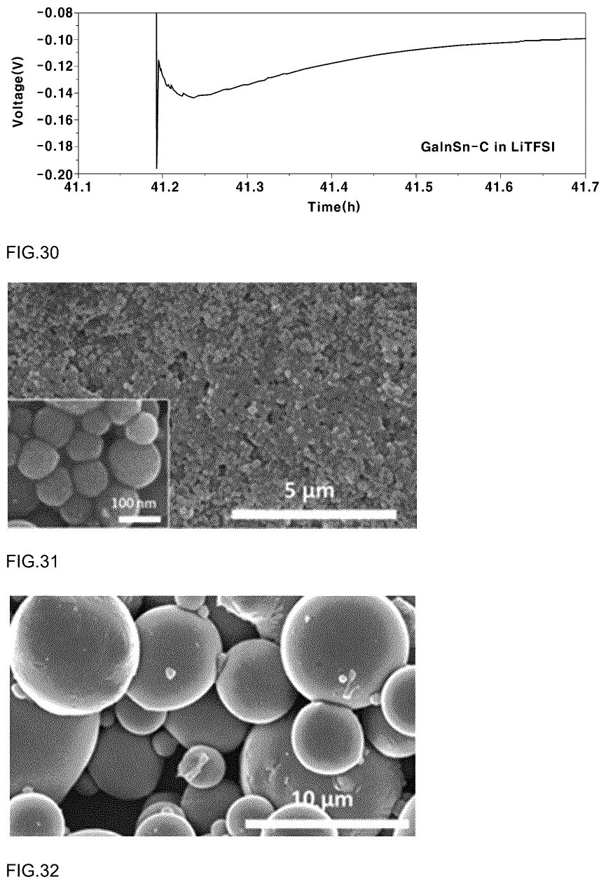

FIG. 26 shows results of measurement of the Coulombic efficiency of Example 7 and Comparative Examples 3 to 5. FIG. 27 shows results of measurement of the nucleation energy of Example 7. FIG. 28 shows results of measurement of the nucleation energy of Comparative Example 3. FIG. 29 shows results of measurement of the nucleation energy of Comparative Example 4. FIG. 30 shows results of measurement of the nucleation energy of Comparative Example 5.

Example 7 exhibited the highest and most stable Coulombic efficiency, whereas Comparative Examples 3 to 5 using liquid electrolytes lacked stability and showed a rapid decrease in Coulombic efficiency. Also, the nucleation overpotential of Example 7 was the lowest.

In Example 7, the electrolyte was initially present in a liquid state, and was easily dispersed through the pores and thus penetrated the composite. After in-situ polymerization at room temperature for 24 hours, the LiFSI electrolyte was converted from a liquid to a polymer electrolyte. This stabilizes the structure and morphology of the electrolyte layer and composite and mitigates risks such as volume expansion, loss of liquid metal particles, and formation of dendrites. In contrast, the electrolytes of Comparative Examples 3 to 5 did not form a strong and stable structure for the composite, resulting in greatly deteriorated cell durability due to volume expansion of the thin film layer during charging and discharging.

### Example 8

An asymmetric cell was manufactured in the same manner as in Example 7, with the exception that liquid metal particles having a size of about 60 nm or less were prepared.

### Comparative Example 6

An asymmetric cell was manufactured in the same manner as in Example 8, with the exception that liquid metal particles having a microscale size of about 2 μm to 10 μm were prepared.

### Comparative Example 7

An asymmetric cell was manufactured in the same manner as in Example 8, with the exception that liquid metal particles having a sub-microscale size of about 300 nm to 500 nm were prepared.

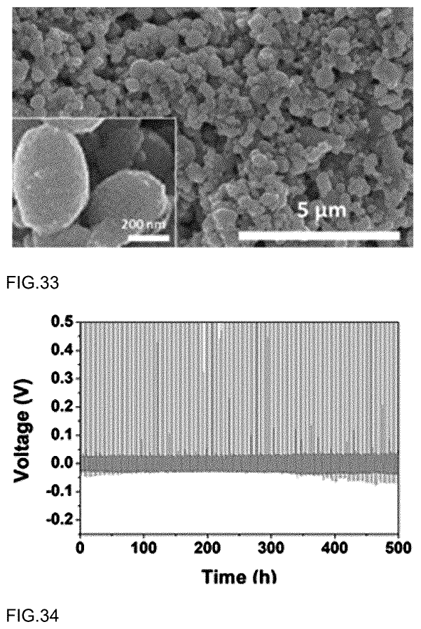

FIG. 31 shows results of scanning electron microscopy of the liquid metal particles of Example 8. FIG. 32 shows results of scanning electron microscopy of the liquid metal particles of Comparative Example 6. FIG. 33 shows results of scanning electron microscopy of the liquid metal particles of Comparative Example 7.

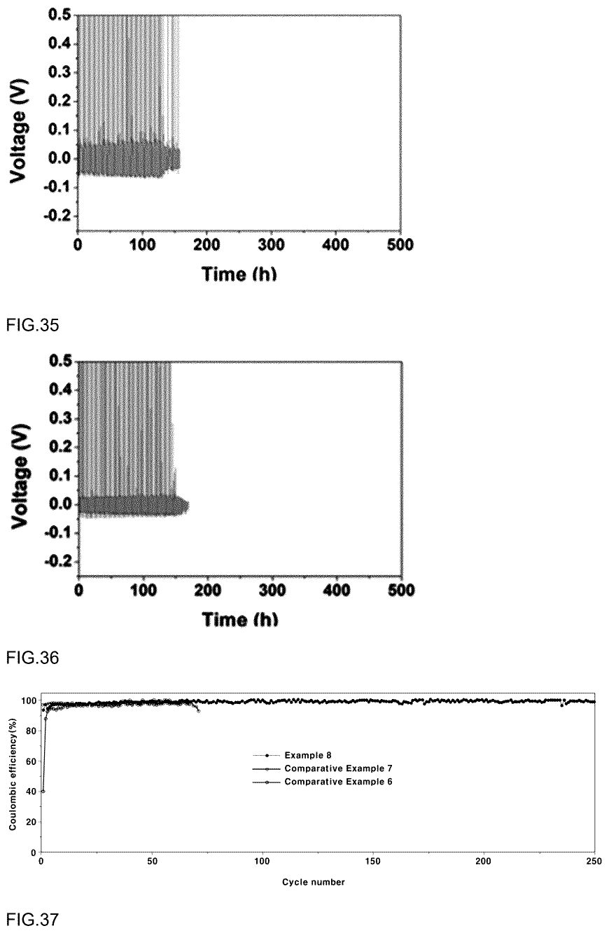

FIG. 34 shows results of evaluation of the cycling performance of Example 8. FIG. 35 shows results of evaluation of the cycling performance of Comparative Example 6. FIG. 36 shows results of evaluation of the cycling performance of Comparative Example 7. Referring thereto, Example 8 exhibited excellent efficiency with a polarization voltage of about 30 mV without a drastic increase in polarization or short circuit for 500 hours, whereas Comparative Examples 6 and 7 short circuited at 130 hours and 150 hours, respectively, and exhibited higher polarization voltages.

FIG. 37 shows results of measurement of the Coulombic efficiency of Example 8 and Comparative Examples 6 and 7. Example 8 had a higher average Coulombic efficiency and a longer lifespan than Comparative Examples 6 and 7.

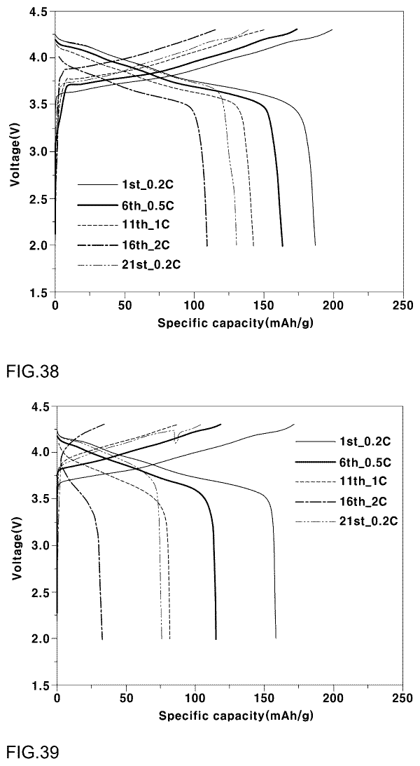

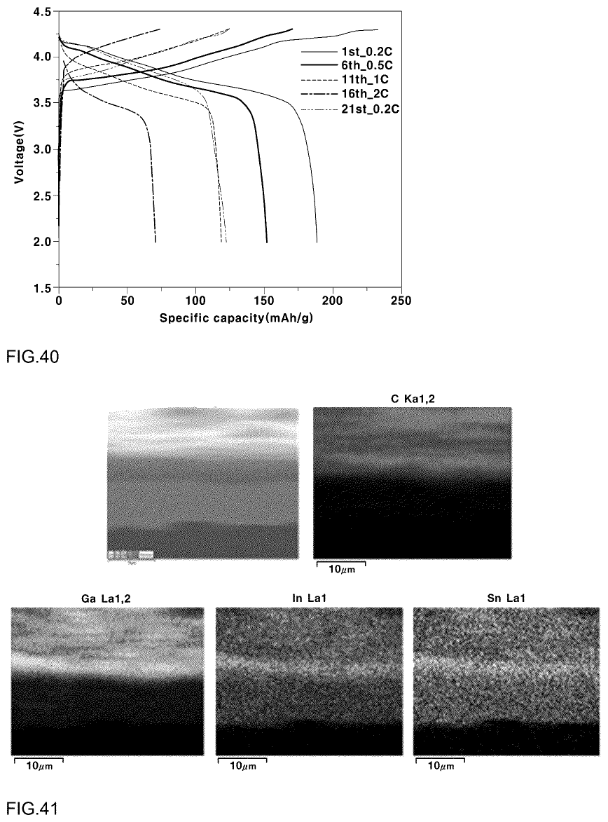

FIG. 38 shows charge/discharge curves of Example 8. FIG. 39 shows charge/discharge curves of Comparative Example 6. FIG. 40 shows charge/discharge curves of Comparative Example 7. Referring thereto, Example 8 had a superior capacity retention rate compared to Comparative Examples 6 and 7.

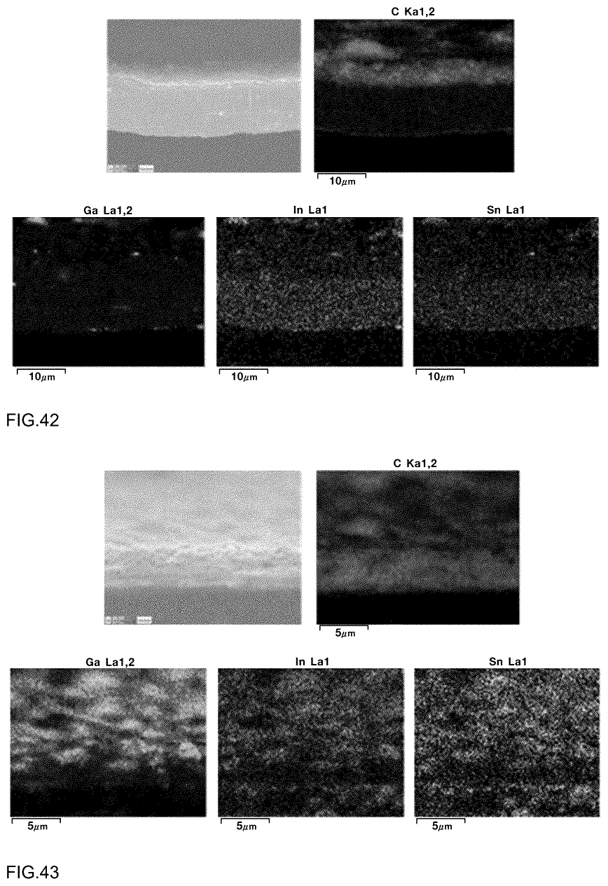

FIG. 41 shows EDS-mapping results of Example 8. FIG. 42 shows EDS-mapping results of Comparative Example 6. FIG. 43 shows EDS-mapping results of Comparative Example 7. Referring thereto, the performance improvement of Example 8 was due to uniform distribution of liquid metal particles.

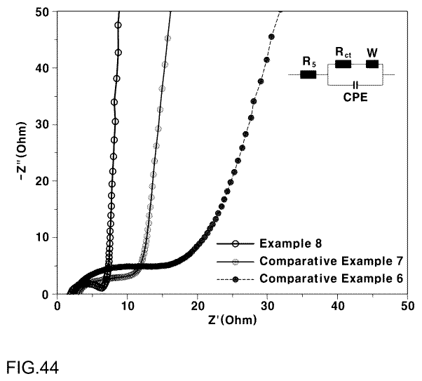

FIG. 44 shows Nyquist plots of Example 8 and Comparative Examples 6 and 7. Example 8, including nanoscale-sized liquid metal particles, had low resistance to charge transfer compared to Comparative Examples 6 and 7.

In conclusion, the size of the liquid metal particles had a great influence on the performance of the lithium secondary battery, and as represented in the present disclosure, the liquid metal particles having a size of about 60 nm or less resulted in the best performance.

As is apparent from the foregoing, according to the present disclosure, an anode-free type lithium secondary battery in which lithium is uniformly deposited during charging and a method of manufacturing the same are provided.

According to the present disclosure, an anode-free type lithium secondary battery having excellent Coulombic efficiency and a method of manufacturing the same are provided.

According to the present disclosure, an anode-free type lithium secondary battery having good cycling performance and a method of manufacturing the same are provided.

According to the present disclosure, an anode-free type lithium secondary battery having excellent stability and high energy density and a method of manufacturing the same are provided.

The effects of the present disclosure are not limited to the foregoing. It should be understood that the effects of the present disclosure include all effects that can be inferred from the description of the present disclosure.

As the test examples and examples of the present disclosure have been described in detail above, the scope of the present disclosure is not limited to the aforementioned test examples and examples, and various modifications and improvements made by those skilled in the art using the basic concept of the present disclosure defined in the following claims are also within the scope of the present disclosure.

What is claimed is:

1. A lithium secondary battery, comprising:
an anode current collector;
a thin film layer disposed on the anode current collector and comprising liquid metal particles;
an electrolyte layer disposed on the thin film layer and comprising a polymer electrolyte;
a cathode active material layer disposed on the electrolyte layer; and
a cathode current collector disposed on the cathode active material layer.

2. The lithium secondary battery of claim 1, wherein the liquid metal particles comprise at least one selected from the group consisting of Ga, Ga—In, Ga—In—Sn, and combinations thereof.

3. The lithium secondary battery of claim 2, wherein the Ga—In comprises 75 wt % of Ga and 25 wt % of In.

4. The lithium secondary battery of claim 2, wherein the Ga—In—Sn comprises 67 wt % of Ga, 20.5 wt % of In, and 12.5 wt % of Sn.

5. The lithium secondary battery of claim 1, wherein a size of the liquid metal particles is 10 nm to 60 nm.

6. The lithium secondary battery of claim 1, wherein a loading amount of the liquid metal particles is 0.5 mg/cm² to 1.0 mg/cm².

7. The lithium secondary battery of claim 1, wherein the thin film layer further comprises a carbon material and a binder.

8. The lithium secondary battery of claim 7, wherein the thin film layer comprises 2 wt % to 10 wt % of the carbon material, 40 wt % to 70 wt % of the liquid metal particles, and 20 wt % to 50 wt % of the binder.

9. The lithium secondary battery of claim 1, wherein a thickness of the thin film layer is 5 μm to 20 μm.

10. The lithium secondary battery of claim 1, wherein the polymer electrolyte comprises a compound represented by Chemical Formula 1 below: 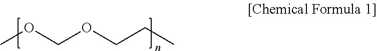
in Chemical Formula 1, n is a number ranging from 1,000 to 10,000.

11. The lithium secondary battery of claim 1, wherein at least a portion of the electrolyte layer penetrates the thin film layer.

12. The lithium secondary battery of claim 1, further comprising a lithium metal layer between the thin film layer and the anode current collector during charging.

13. The lithium secondary battery of claim 1, wherein peaks are observed at 2θ=25°±0.5° and 40°±0.5° based on results of X-ray diffraction analysis for the thin film layer during charging of the lithium secondary battery.

14. A method of manufacturing a lithium secondary battery, comprising:
forming a thin film layer by applying a mixture comprising liquid metal particles, a carbon material, and a binder onto an anode current collector;
forming an electrolyte layer comprising a polymer electrolyte by applying an electrolyte composition onto the thin film layer and polymerizing the electrolyte composition; and
introducing a cathode active material layer and a cathode current collector onto the electrolyte layer.

15. The method of claim 14, wherein the liquid metal particles comprise at least one selected from the group consisting of Ga, Ga—In, Ga—In—Sn, and combinations thereof.

16. The method of claim 14, wherein a size of the liquid metal particles is 10 nm to 60 nm,
wherein a loading amount of the liquid metal particles is 0.5 mg/cm² to 1.0 mg/cm²,
wherein the thin film layer comprises 2 wt % to 10 wt % of the carbon material, 40 wt % to 70 wt % of the liquid metal particles, and 20 wt % to 50 wt % of the binder, and
wherein a thickness of the thin film layer is 5 μm to 20 μm.

17. The method of claim 14, wherein the electrolyte composition comprises 3 M or more of a lithium salt; and a solvent comprising a heterocyclic compound.

18. The method of claim 17, wherein the lithium salt comprises lithium bis(trifluoromethanesulfonyl)imide (LiFSI), and the solvent comprises 1,3-dioxolane, and optionally, the solvent further comprises 1,2-dimethoxyethane.

19. The method of claim 14, wherein forming the electrolyte layer comprises applying an electrolyte composition onto the thin film layer and allowing the electrolyte composition to stand at 20° C. to 25° C. for 24 hours or more to polymerize the electrolyte composition.

20. The method of claim 14, wherein the polymer electrolyte comprises a compound represented by Chemical Formula 1 below: 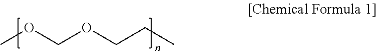
in Chemical Formula 1, n is a number ranging from 1,000 to 10,000,
wherein at least a portion of the electrolyte layer penetrates the thin film layer,
wherein the lithium secondary battery further comprises a lithium metal layer between the thin film layer and the anode current collector during charging, and
wherein peaks are observed at 2θ=25°±0.5° and 40°±0.5° based on results of X-ray diffraction analysis for the thin film layer during charging of the lithium secondary battery.
